(19) United States
(12) Patent Application Publication
(10) Pub. No.: US 2002/0021076 A1
(43) Pub. Date: Feb. 21, 2002

(54) GRIDS

(76) Inventors: DAVID WARD CARR, CHELMSFORD (GB); ALAN HUGH PICKERING, CHELMSFORD (GB)

Correspondence Address: DONALD C CASEY ESQ, 311 NORTH WASHINGTON STREET, SUITE 100, ALEXANDRIA, VA, 22314

(21) Appl. No.: 09/096,473

(22) Filed: Jun. 12, 1998

(30) Foreign Application Priority Data
Jun. 13, 1997 (GB) 9712243.6

(51) Int. Cl. H01J 1/62

(52) U.S. Cl. 313/414

(57) ABSTRACT

A grid for use in a linear electron beam tube such as an IOT or TWT includes a grid section and a focus electrode between which is included an accommodation portion. The grid is mounted in the tube by a mounting flange around its outer periphery. During use, the grid section becomes hot and consequently expands but the mounting flange remains relatively cool being connected to a relatively massive structure. Thin flexible strips of the accommodation section permit movement between the mounting flange and the grid section due to differential thermal expansion, thus minimising distortion to the grid section which might otherwise occur if it were connected directly to the mounting flange and hence fixed in its outer diameter length. In other embodiments, the focus electrode is omitted.

### FIELD OF THE INVENTION

This invention relates to grids and more particularly grids for use in linear beam tubes such as inductive output tubes (IOTs).

### BACKGROUND OF THE INVENTION

In an IOT, an electron beam is produced at a cathode and an anged to interact with an applied high frequency signal to give an amplified high frequency output signal. A grid is located in front of the cathode to control the density of the electron beam, the high frequency signal being applied across the gap between the cathode and the grid to modulate the beam density. The cathode and grid must therefore be accurately located relative to one mother. A focus electrode is normally used to define the profile of the electron beam. Other types of linear beam tubes also employ grids, for example, they are also used in travelling wave tubes (TWTs). During operation, the grid gets hot, which may cause problems in controlling the electron beam density.

The present invention seeks to provide an improved grid which may be advantageously used in TOTs in particular. However, the invention may also be applied to other types of linear beam tube such as TWTs, triodes and tetrodes.

### SUMMARY OF THE INVENTION

According to a first aspect of the invention, a grid for an electron beam tube comprises a grid section and a focus electrode. Thus, a single element combines a grid section, which may have the same configuration and dimensions of a conventional grid, and a focus electrode. It is not therefore necessary to separately mount two elements as in a conventional system.

It is believed by the inventor that a conventional IOT grid may become significantly distorted in operation from its original spherical profile. In a conventional arrangement, the grid is continuous at its outer periphery with a circular mounting flange by means of which it is fixed to a grid support. The grid is either integral with the mounting flange or fixed to it. During operation, the grid itself is heated by radiation from the cathode, by electron interception and by rf currents. However, the surrounding mounting flange is cooled as it is clamped to a substantial support structure which acts as a heat sink. As a result, expansion of grid wires across the grid diameter with increasing temperature causes the centre o the grid to move closer to the cathode than the periphery of the grid, the position of which i fixed by the mounting flange. The profile of the grid thus distorts from the generally spheri al shape, resulting in variation of electron current density with radius.

Accordingly, in a particularly advantageous embodiment of the invention, in accommodation portion is included, preferably between the grid section and the focus electrode, which is deformable. The accommodation portion of the grid allows for differential expansion between the grid section and the mounting flange caused by temperature differences. The grid section is relatively rigid compared to the accommodation portion. Thus, although the members making up the grid section expand, the distortion of the grid section from a spherical profile, as occurs with a conventional grid is much reduced as the deformable accommodation portion does not restrict the outer diameter of the grid section but allows it to increase. The accommodation portion may alternatively be located between the focus electrode and the mounting flange, the outer periphery of the grid section and the focus electrode being adjacent one another. However, this arrangement is likely to be of less benefit as the focus electrode in most cases is relatively rigid and hence will tend to x the outer diameter of grid section. However, the focus electrode will itself also expand with temperature to some extent and is also separated from the cooler mounting flange by the accommodation portion, giving some reduction in distortion of the grid section.

In one preferred embodiment the accommodation portion comprises a plurality of axial strips arranged between the outer periphery of the grid section and the inner periphery of the focus electrode. The strips are dimensioned so that they flex radially to allow for changes in diameter of the grid section relative to the surrounding mounting flange caused by temperature differences. Other types of accommodation portion may be included providing that it is sufficiently flexible to allow the the required movement to occur and to give a structurally sound design. For example, in another embodiment, the accommodation portion may be a corrugated cylinder such that changes in the dimensions between the grid section and the mounting flange are taken up by folds of the corrugated cylinder moving towards one another. The thickness of the accommodation portion may be less than that of other parts of the grid to give increased flexibility.

In a particularly advantageous embodiment of the invention, the accommodation portion is located between the grid section and the focus electrode. However, benefits may still be obtained in a grid in which a focus electrode is not included. Thus, according to a second aspect of the invention, a grid for an electron beam tube comprises a grid section, a mounting flange and an accommodation portion adjoining and between them.

The grid may be formed of pyrolytic graphite. However, the invention is also applicable to metallic grids. Although it will usually be more convenient for the par of the grid to be formed as an integral single element, in other embodiments, parts maybe fabricated separately and subsequently joined together to form the complete grid.

The grid may be part spherical in form, but the benefits of the invention ar also applicable to a planar grid or to grids of some other shape.

Where the accommodation portion of the grid comprises a plurality of strips, in one advantageous embodiment of the invention, the strips are configured such that one end of each strip is connected to the grid section and the other end of each strip to the foc s electrode, or to the mounting flange as appropriate. In such an embodiment, the grid section may include radially extensive members in which case, preferably, strips of the accommodation portion are contiguous with said members. This provides a good mechanical construction which may also be readily fabricated.

Usually the mounting flange is a continuous flat annulus. However it may comprise separate discontinuous sections or provide other means for mounting the grid in a t be.

According to a first feature of the invention, an electron gun assembly comp ises a grid in accordance with the first or second aspect of the present invention

According to a second feature of the invention, a linear electrc a beam tube c mprises a grid in accordance with the first or second aspect of the present invention.

### BRIEF DESCRIPTION OF DRAWINGS

Some ways in which the invention may be performed are now described by ay of example with reference to the accompanying drawings, in which:

FIG. 1 schematically shows in section a conventional grid;

FIG. 2 schematically shows in section a grid in accordance with the inven ion;

FIG. 3 shows schematically and in perspective the grid of FIG. 2;

FIG. 4 schematically illustrates in section another grid in accordance with the invention; and

FIG. 5 schematically illustrates an IOT in accordance with the present inv ntion.

### DESCRIPTION OF PREFERRED EMBODIMENTS

With reference to FIG. 1, a conventional grid for use in an IOT, for examp e, comprises a grid 1 having crossing wires, typically in a pattern comprising radial sp kes with circumferential rings connecting them. A mounting flange 2 is connected to the ou or periphery of the grid 1 and has a plurality of apertures therethrough (not shown) via which pins of a relatively massive grid support are located to secure the grid in position in the tube. A separate beam focussing electrode, such as a Wehnelt cylinder, at grid potential may also be included to control the beam profile and conventionally is a separate massive me l component.

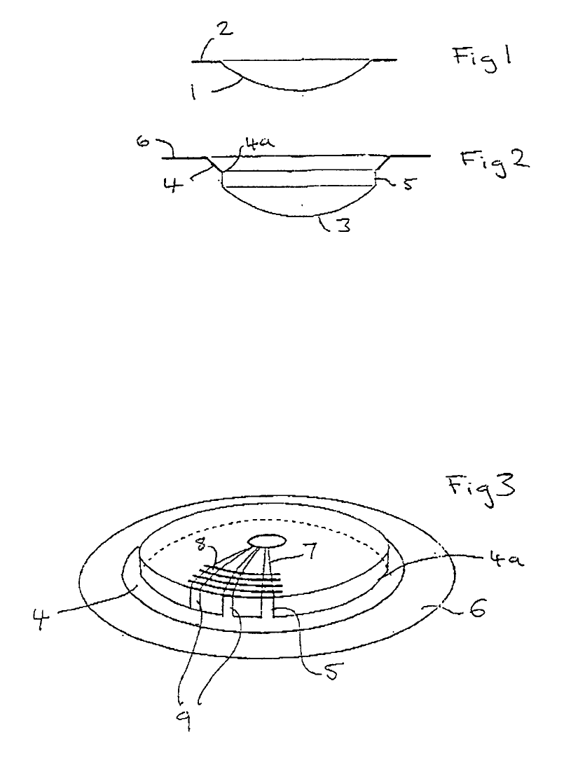

With reference to FIGS. 2 and 3, a grid in accordance with the invention inc udes a grid section 3, a focus electrode 4 and accommodation portion 5 extending between em. A mounting flange 6 is contiguous with the outer periphery of the focus electrode 4. The focus electrode 4 is configured as a Welnelt cylinder.

The grid section has a spherical profile and comprises conductive radially extending supports 7 spaced equidistantly from one another and circumferential rings 8 to wh ch they are connected, only some of which are shown. Other configurations may, of cours , be used instead. In this embodiment, the accommodation portion 5 comprise a plurality o thin strips 9 extending generally axially between respective ones of the radial supports 7 of the grid section 3 and the inner periphery 4a of the focus electrode 4, the axial direction being the longitudinal axs of the tube parallel to the electron beam path. In this case, the nu ber of strips 9 corresponds to the number radial supports 7.

The grid is of pyrolytic carbon and is formed as a single element. It is fabri ated by depositing the carbon on a former which defines the shapes of the mounting flange, focus electrode, cylindrical accommodation portion and the spherical profile of the grid se ction. The required grid section profile and the strips of the accommodation portion are th n defined by laser cutting. The strips of the accommodation portion are arranged to have a si ilar width and thickness to the radial supports of the grid section 3.

During operation of the IOT, the strips 9 are able to flex in a r dial direction and to deform to allow for difference in the changes in diameter between the relatively rigi grid section 3 and the focus electrode 4 and the mounting flange 6 due to temperature di erences.

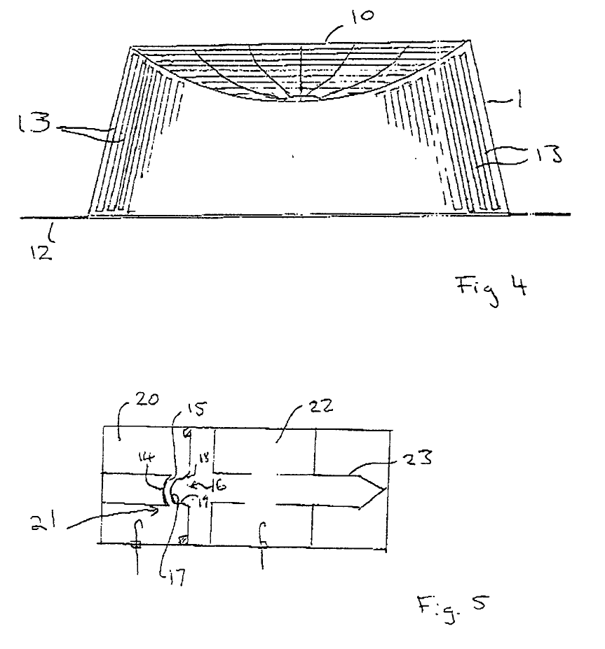

FIG. 4 shows another grid in accordance with the invention which does not incorporate a focus electrode. A grid section 10 is supported by a conical support st cture 11 which is connected to a mounting flange 12 by which the grid is fixed in the tube. The grid section 10 has ar arrangement of crossing conductive members ir a convention configuration. The conical support 11 has a plurality of axial slots 13 (only some f which are shown) cut through its walls to provide an accommodation portion which is deformable. During operation of a tube in which the grid is included, the mounting flange 12 remains relatively cool whereas the grid section 10 increases significantly in temperature. The accommodation portion 11 flexes to permit expansion of the grid section 10 withc it unduly restricting it. Hence, distortion of the grid section from its desired profile is reduc d compared to that which would occur for a similar conventional grid.

FIG. 5 schematically illustrates an IOT in accordance with the invention. It comprises a cathode 14 having a spherical front surface 15 in front of which is loc ted a grid 16 of the type shown in FIGS. 2 and 3. The grid 16 includes a grid section 17, a focus electrode 18 and accommodation portion 19. A cylindrical resonant input cavity 2 surrounds the electron gun structure 21. An output resonant cavity 22 is used to extract an amplified signal following its interaction with the electron beam produced by the cathode 14. A collector 23 is arranged to receive electrons of the beam after they have travelled through the resonant cavity 22. It is not necessary to include another focus electrode in addtion to that incorporated in the grid 16 to obtain the required beam profile.

A grid such as that illustrated in FIG. 4 may be used in place of the grid shown in the IOT but in this case a separate focus electrode is advantageously included to control the beam profile.

We claim:

1. A grid for an electron beam tube comprising a grid section and a focus electrod.

2. A grid as claimed in claim 1 wherein said grid section and said focus electrode are of pyrolytic graphite.

3. A grid as claimed in claim 1 wherein said grid section is part-spherical.

4. A grid as claimed in claim 1 and including an accommodation portion which is deformable.

5. A grid as claimed in claim 4 wherein said accommodation portion is located between said grid section and said focus electrode.

6. A grid for an electron beam tube comprising a grid section comprising a mesh o electrically conductive members, an annularring which surrounds said grid section and a deformable accommodation portion located between said grid section and said annularring.

7. A grid as claimed in claim 6 and including a focus electrode located between said grid section and said annular ring.

8. A grid as claimed in claim 6 wherein said grid section, said annular ring and said accommodation portion are of pyrolytic graphite.

9. A grid as claimed in claim 6 wherein said grid section is part-spherical.

10. A grid as claimed in claim 6 wherein said mesh comprises a plurality of radial members and a plurality of circumferential members.

11. A grid as claimed in claim 6 wherein said accommodation portion comprises a plurality of radially extensive strips.

12. A grid as claimed in claim 11 wherein said mesh includes a plurality of radial members and strips of said plurality of radially extensive strips are contiguous with radial members of said mesh.

13. A grid as claimed in claim 6 wherein said annularring, said grid section and said accommodation portion are formed as an integral single element.

14. A grid as claimed in claim 6 wherein said accommodation portion is extensive a direction in front of said grid section.

15. A grid as claimed in claim 6 wherein said accommodation portion is extensive in a direction behind said grid section.

16. An electron gun assembly including a grid comprising a grid section and a focus electrode.

17. An electron gun assembly including a grid comprising a grid section comprising a mesh of electrically conductive members, an annularring which surrounds said grid section and a deformable accommodation portion located between said grid section and said annularring.

18. A linear electron beam tube including a grid comprising a grid section and a focus electrode.

19. A linear electron beam tube including a grid comprising a grid section comprising a mesh of electrically conductive members, an annular ring which surrounds said grid section and a deformable accommodation portion located between said grid section and said annular ring.
